(19) United States
(12) Patent Application Publication
(10) Pub. No.: US 2010/0132805 A1
(43) Pub. Date: Jun. 3, 2010

(54) AIR VENT VALVE FOR BEVERAGE MAKERS

(75) Inventors: Girish S. Kshirsagar, Lenexa, KS (US); Dharmesh A. Ved, Overland Park, KS (US); John Erick Ellison, Shawnee, KS (US); Winston Fliess, Olathe, KS (US); David Weiss, Shawnee, KS (US); Nathaniel F. Yoder, Kingsville, MO (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: B/E INTELLECTUAL PROPERTY, Lenexa, KS (US)

(21) Appl. No.: 12/625,507

(22) Filed: Nov. 24, 2009

Related U.S. Application Data
(62) Division of application No. 11/407,341, filed on Apr. 19, 2006.

(51) Int. Cl. F16K 24/04

(52) U.S. Cl. 137/202

(57) ABSTRACT

The air vent valve includes a vent valve body and a valve adapter that sealingly mate together. A vent outlet of the vent valve body and a fluid inlet of the valve adapter are connected through interior flow chambers of the vent valve body and valve adapter. A spherical ball float is constrained for longitudinal movement within a tubular collar in the interior chamber of the vent valve body, and a planar valve seat member with a central flow aperture is disposed within the vent valve body between the tubular collar and the outflow passage of the vent valve body.

### CROSS-REFERENCES TO RELATED APPLICATIONS

This divisional application is based upon and claims the benefit of priority from the prior U.S. patent application Ser. No. 11/407,341, filed Apr. 19, 2006, and U.S. Provisional Patent Application Ser. No. 60/673,538, filed Apr. 20, 2005, the entire contents of which are incorporated herein by reference.

### BACKGROUND OF THE INVENTION

The invention generally relates to commercial and consumer products related to venting and draining of containers, and more particularly relates to venting and draining of beverage makers for aerospace applications. The invention is specifically suitable for applications that typically handle fluids and depend on a mechanical or electrical means to ensure reliable venting of air into or out of a container, such as a tank assembly in the case of a beverage maker.

Air vent valves are typically used in aircraft beverage makers in conjunction with filling and draining a fresh water tank assembly, but in the past such air vent valves frequently have not been as reliable as desired to meet stringent quality standards. While a number of variations of air vent valve systems currently exist, they are all primarily of the float type. In these devices, a plastic or metal float is pushed up by liquid filling a tank to shut a vent hole during a filling operation, and conversely the float drops away from the vent hole to open up the vent during drainage of the liquid from the tank. These floats are susceptible to wear and tear (typically pitting due to mechanical pounding particularly compounded by chattering and cracking) which then results in a leak, because the body surface of the float is no longer smooth enough to seat properly against the vent hole.

Floats may also not be able to seal properly due to wear and tear of the seat against which the float seals, because of high impact to the valve seat after some usage, from a variety of factors. This causes leaks which, depending on the galley configuration, can be sufficient to cause a wet carpet condition in the aircraft, which is clearly not desirable. Also, a float can at times become stuck in a seated position in an air vent valve, which prevents drainage of liquid from the beverage maker, resulting in an inoperative condition. A common complaint from the customers is that such beverage makers for aerospace application become inoperative due to failure of an air vent valve, since having a beverage maker out of service due to a relatively inexpensive component is very expensive for an airline. Another major disadvantage of some conventional air vent valves is that the valves can vibrate or chatter in an audible manner in the operating pressure range of the tank on an aircraft. This chatter is not only annoying, but is usually also sufficiently prolonged to cause continuous leaks during that time. The chattering and vibration shortens useful life of the vent valve, lowering customer satisfaction and causing higher warranty costs. It would therefore be desirable to provide an air vent valve assembly that substantially eliminates chattering and vibration of the vent valve assembly to improve the useful operating life and reliability of the vent valve assembly. The present invention meets these and other needs.

### SUMMARY OF THE INVENTION

The vent valve of the invention is ordinarily situated on top of the tank of a beverage maker, and is useful for filling and draining the water tank. During a filling operation, the vent valve provides a vent so the air in the tank can escape through it and it shuts close once the tank is full. Similarly, when draining is needed, it allows air from outside to get into the tank from the top of the tank as water is drained from the bottom of the tank.

The present invention accordingly provides for an air vent valve assembly for a tank assembly of a beverage maker for aircraft, including a vent valve body having an interior chamber and an outlet flow passage in fluid communication with the interior chamber, and a valve adapter that sealingly mates with the vent valve body, and that is adapted to be removably attached to the tank assembly of the beverage maker. In a presently preferred aspect, the vent valve body includes an outer annular flange with an externally threaded surface, and the valve adapter includes an upper annular flange with an internally threaded surface that mates with the externally threaded surface of the vent valve body. In one presently preferred aspect, a barbed tube fitting is attached to the outlet flow passage to allow for exchange of outside air through the vent valve assembly.

The valve adapter has an interior flow chamber connected in fluid communication with the interior chamber of the vent valve body, and a flow inlet connected in fluid communication with the interior flow chamber of the valve adapter. A tubular collar having a lumen therethrough is disposed within the interior chamber of the vent valve body, and a planar valve seat member having a central flow aperture is disposed within the interior chamber of the vent valve body between the tubular collar and the outflow passage of the vent valve body. A spherical ball float having a first valve seating position abutting and closing the central flow aperture of the planar valve seat member, and a second unseated position spaced apart from and opening the central flow aperture of the planar valve seat member, is movably disposed within the lumen of the tubular collar. In a presently preferred aspect, the tubular collar is made of a corrosion resistant material, such as polytetrafluoroethylene, for example; the planar valve seat member is made of a soft, resilient elastomeric material such as silicone, for example; and the spherical ball float is made of a tough, corrosion resistant polymer, such as high density polyethylene (HDPE), and weighs about 0.4 g., for example.

In another presently preferred aspect, the lumen of the tubular collar has an internal diameter of approximately 0.406 inch, the spherical float has a diameter of approximately 0.375 inch; and the spherical float moves within the lumen of the tubular collar and is constrained for limited travel of a maximum of 0.041 inches longitudinally within the lumen of the tubular collar.

In one presently preferred embodiment, a keeper member is disposed in the valve adapter for retaining the spherical ball float within the tubular collar, and constraining the travel of the spherical ball float within the lumen of the tubular collar. In a presently preferred aspect, the keeper member is formed of spring steel, and may be a triangular clip, having a first side arm, a second side arm, a first side base free end, and a second side base free end. In another presently preferred aspect, the keeper member may be a C-shaped clip. In a presently preferred aspect, the valve adapter has a surface defining an interior shoulder seating the keeper member, and for seating an O-ring forming a fluid seal between the vent valve body and the valve adapter.

In another presently preferred embodiment, the valve adapter that sealingly mates with the vent valve body is configured such that no internal clip is necessary to retain the ball float within the tubular collar when the ball float is at the bottom of the tubular collar. The internal dimensions of the tubular collar and valve body are essentially unchanged from the first embodiment, but the configuration of the valve adapter and elimination of the keeper member allow for simplification of the design and reduction in weight of the valve by nearly 50%, and may be suitable in cases where a lower profile (height) is desirable due to space constraints or requirements for lighter weight due to design specifications.

The present invention is specifically suited for the needs of beverage makers and is relatively simple to manufacture, compact and lightweight. It is also robust and resistant for wear and tear, which means lower maintenance costs for the customer. Technically, it has also solved three major problems—(a) susceptibility to getting stuck in closed position (and thereby preventing normal tank filling and draining operation), (b) chattering associated with the flow dynamics within the valve, (c) leaks that typically result from either wear or tear during normal course of operation or due to flow dynamics of the system.

Analysis of repair data for beverage makers has demonstrated that the air vent valve is a part that is critical if reliability of beverage makers is to be improved for higher customer satisfaction and reduced warranty costs. The present invention has been determined to be very robust and less expensive to manufacture than the existing designs.

An analysis of system dynamics of the air vent valve has shown that the pressure drop across the vent opening and the mass of the float are critical to proper functioning of the valve. The invention recognizes these critical parameters and exploits them to ensure robust performance of the valve to eliminate chattering and leaks. In addition, the design provides a durable and reliable means to secure the ball in place in the shut position to minimize wear and tear of the float and associated seating related components.

One important advantage of the invention is the elimination of chattering. Based on the theoretical and experimental findings, the vent opening and the ball weight are critical to robust (and chatter-free) performance. The invention recognizes that to assure robust performance, the flow through the vent opening must be high so that the system dynamics are outside the range of oscillatory (chattering) zone. This is achieved by keeping proper vent hole size in relation to the rest of parameters such as float weight that affect system dynamics.

Another aspect of the invention is the minimization of the length of time for the air vent valve to open or close. This is achieved by adjusting the weight of the float in relation to the vent hole size and expected operating pressure range of the main tank that supplies water to the tank assembly of the beverage maker. In addition, by minimizing the range of movement of the ball, the ball is quickly able to shut the vent hole during the filling operation. The collar allows optimizing the ball size and indirectly therefore the weight by controlling the size of passage within which the ball is restricted to move, which has direct bearing on the time to shut the vent hole. This way, the outside body of the valve can still be kept in line with torque forces that are typically encountered during assembly or maintenance operations.

Another advantage of the invention is the elimination of leaks. This design has been found to be completely leak-proof, by minimizing the time to shut the vent hole. The design utilizes a spherical float to minimize the possibility of misalignment of the float with the seat. Also, by keeping the contact area low, it naturally prevents sticking.

Another advantage of the invention is the improvement of the useful life of the air vent valve by eliminating factors that lead to failures. For example, depending on the quality of water there can be significant amount of scale build-up. A collar made of a smooth, corrosion resistant material adds to the reliability of the valve by not allowing salt deposition, which particularly becomes worse once there is corrosion due to roughness of the surface. This salt deposition can otherwise affect the movement of the float, and hence lead to unreliable sealing that can result in leaks.

Another advantage of the invention is the minimization of wear and tear of components during the lifetime of the air vent valve assembly. This is accomplished by eliminating chattering, and by providing a soft sealing surface against which the float impinges in the course of its operation. The surface of the ball thereby remains smooth, and is therefore not susceptible to leaking or salt deposition.

Other features and advantages of the present invention will become more apparent from the following detailed description of the preferred embodiments in conjunction with the accompanying drawings, which illustrate, by way of example, the operation of the invention.

### BRIEF DESCRIPTION OF THE DRAWINGS

FIG. 1 is a schematic diagram of a prior art beverage maker vent valve.

FIG. 2 is a graph illustrating system behavior according to data from a prior art vent valve.

FIG. 3 is a side elevational view of a first embodiment of an air vent valve for beverage makers according to the present invention.

FIG. 4 is a top plan view of the air vent valve of FIG. 3.

FIG. 5 is an exploded perspective view of the air vent valve of FIG. 3.

FIG. 6 is a perspective view of the collar of the air vent valve of FIG. 3.

FIG. 7 is a plan view of the float of the air vent valve of FIG. 3.

FIG. 8 is a perspective view of the seating washer of the air vent valve of FIG. 3.

FIG. 9 is a top plan view of the keeper spring of the air vent valve of FIG. 3.

FIG. 10 is a perspective view of the adapter of the air vent valve of FIG. 3.

FIG. 11 is a top plan view of the adapter of FIG. 10.

FIG. 12 is a side elevational view of the adapter of FIG. 10.

FIG. 13 is a sectional view of the adapter taken along line 13-13 of FIG. 12.

FIG. 14 is a top plan view of a second embodiment of an air vent valve for beverage makers according to the present invention.

FIG. 15 is a cross-sectional view of the air vent valve taken along line 15-15 of FIG. 14.

FIG. 16 is an exploded view of the air vent valve of FIG. 14.

FIG. 17 is a perspective view of the adapter of the air vent valve of FIG. 14.

FIG. 18 is a bottom plan view of the adapter of FIG. 17.

FIG. 19 is a side elevational view of the adapter of FIG. 17.

FIG. 20 is a sectional view of the adapter taken along line 20-20 of FIG. 19.

FIG. 21 is a bottom plan view of the interior of the adapter of FIG. 17.

FIG. 22 is a perspective view of the vent valve body of the air vent valve of FIG. 14.

FIG. 23 is a side elevational view of the vent valve body of the air vent valve of FIG. 14.

FIG. 24 is a top plan view of the vent valve body of the air vent valve of FIG. 14.

FIG. 25 is a cross-sectional view of the vent valve body taken along line 25-25 of FIG. 24.

FIG. 26 is a top plan view of the barbed tube fitting of the air vent valve of FIG. 14.

### DETAILED DESCRIPTION OF THE PREFERRED EMBODIMENTS

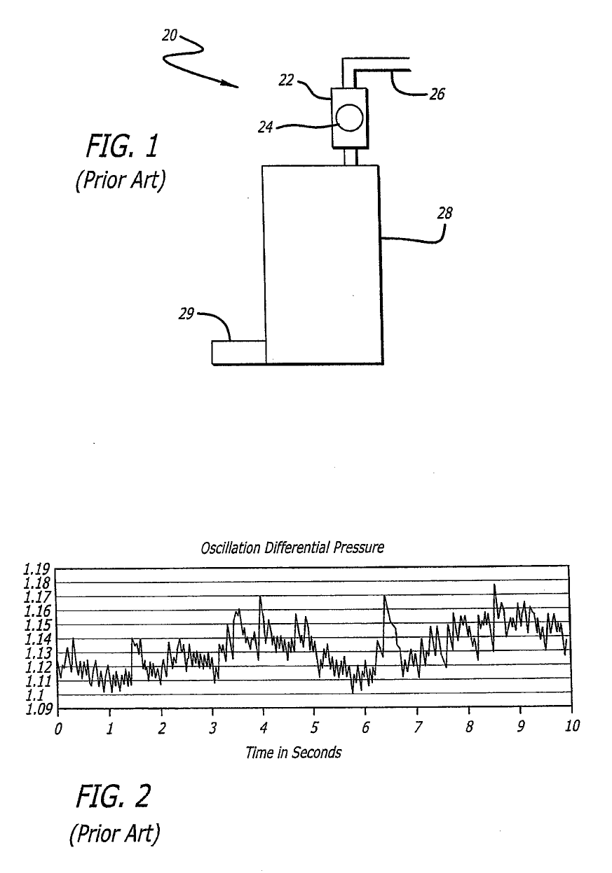

Referring to FIG. 1 illustrating a schematic diagram of a prior art beverage maker vent valve, a vent valve assembly or fluid flow element (FFE) 20 includes a valve body 22 housing a float or valve element (VE) 24, controlling fluid flow to and from the vent outlet 26 from the water tank, or chamber, or fluid volume element (FVE) 28, which receives water through the water inlet 29. From a system dynamics point of view, the elements that describe the essential elements of the system are the fluid flow element (FFE) 20, the fluid volume element (FVE) 28, and the valve element (VE) 24.

The change in rate of flow of fluid with time (t) across the fluid flow element is governed by the equation (1) below.

dφ/dt=(A/L)(Pᵢₙ−Pₒᵤₜ−Pₗₒₛₛ−P_{head})/ρ (1)

Where,

φ=Flow rate, A=Cross sectional area of flow path, L=Length of flow path
Pᵢₙ=Inlet pressure, Pout=Outlet pressure, Ploss=Pressure loss due to friction and bends etc
P_{head}=Head pressure loss between upstream and downstream points
ρ=Fluid density (water density).

Using the FVE we can calculate the change is system pressure as follows,

dP/dt=(β/V)(φᵢₙ−φₒᵤₜ) (2)

Where,

β=Bulk modulus of the chamber, water and air combined, V=Volume of the chamber

Finally, we describe the motion of the float using Newton's Second Law in equation (3) below.

d²z/dt²=(F_{drag}−W_{float}−Fₛₑₐₜ)/m_{float} (3)

Where,

z=the distance traveled by the float, F_{drag}=Drag force on the float, W_{float}=Weight of the float Fₛₑₐₜ=reaction force from the seat of the valve, m_{float}=mass of the float Equations (1) through (3) are coupled differential equations that can be solved numerically to model the system behavior including chattering as shown in FIG. 2 showing a graph illustrating system behavior according to actual data from a prior art vent valve. Without going into further details of system dynamics, it can be clearly seen that the pressure drop across the vent opening and the mass of the float are critical to proper functioning of the valve. The applicable analysis of fluid dynamics apply equally to the first and second embodiments.

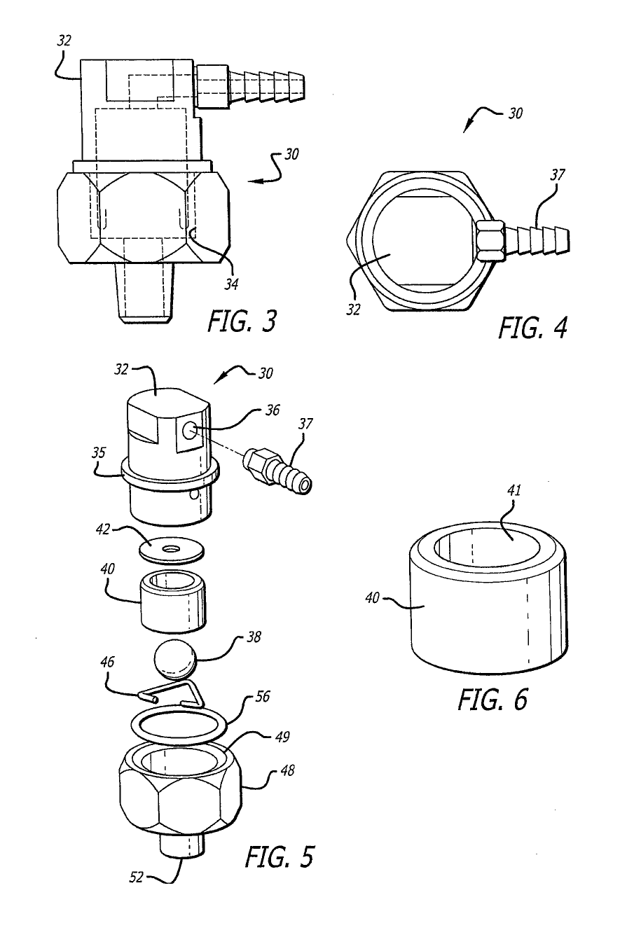

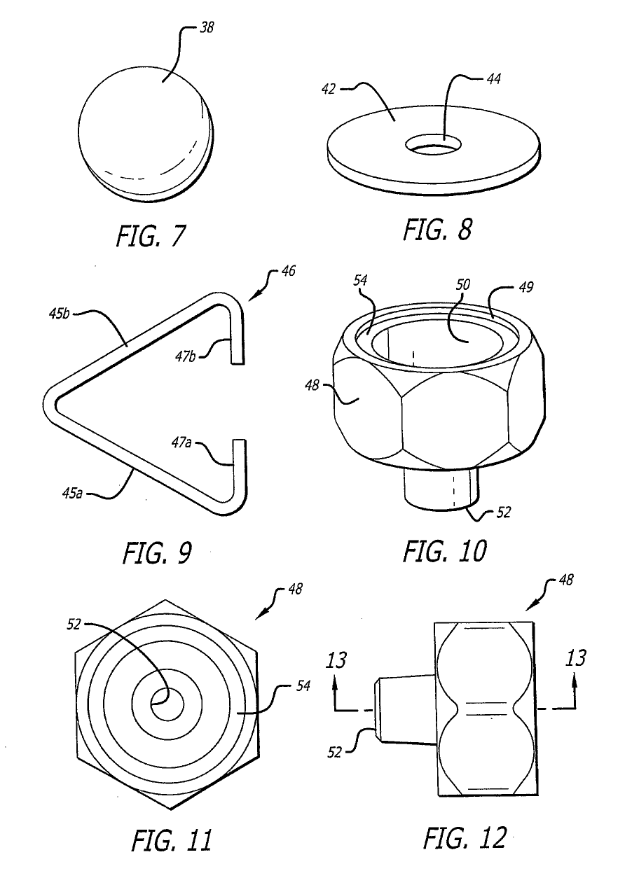

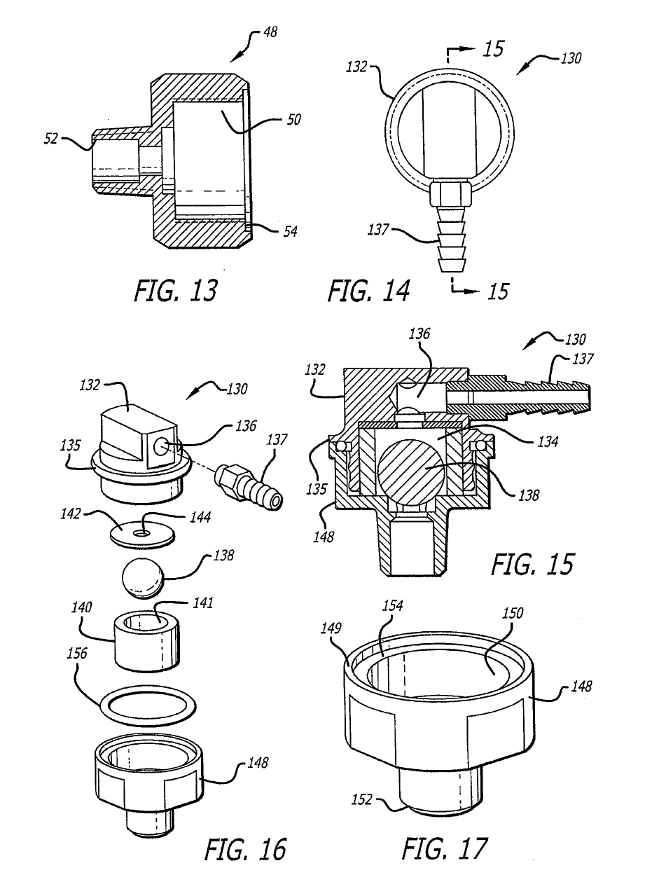

Referring to FIGS. 3-13, the present invention accordingly provides for an air vent valve assembly 30 having a vent valve body 32, typically made of stainless steel, with an interior chamber 34 illustrated in FIG. 3. As is best seen in FIG. 4, the vent valve body includes an outlet flow passage 36 in fluid communication with the interior chamber of the vent valve body. The vent valve body includes an outer annular flange 35 with an externally threaded surface. A barbed tube fitting 37 is attached to the outlet flow passage, allowing for exchange of outside air through the vent valve assembly.

Referring to FIGS. 5, 6 and 7, a spherical ball float or valve element 38, typically made of a tough, corrosion and heat resistant polymer, such as high density polyethylene (HDPE), for example, is movably disposed within a lumen 41 of a tubular collar, or liner 40, which is preferably made of a corrosion resistant material, such as polytetrafluoroethylene (PTFE), available under the trade name TEFLON, for example. In a presently preferred aspect, the lumen of the tubular collar has an internal diameter of about 0.406 inch, and the spherical float has a diameter of about 0.375 inch.

With reference to FIGS. 5, 8 and 9, the collar is disposed within the interior chamber of the vent valve body between a planar valve seat member or washer 42 having a central flow aperture or vent opening 44, and a keeper 46. In a presently preferred aspect, the planar valve seat member is made from a soft, resilient elastomeric material, such as silicone, for example, providing the valve seat member with a sufficiently smooth finish to accomplish a leak-free seal by the float against the vent outlet opening in the internal chamber of the vent valve body. The planar valve seat member typically has a Shore A hardness or Durometer of approximately 20-25, with an operating temperature range of about 32-250° F. In a presently preferred aspect, the vent opening of the valve seat member of the vent valve assembly is optimized to allow the flow of air at sufficient rates to disallow instability. For example, a vent opening diameter of about 0.16 inch was found sufficient to relieve air flow at the expected water fill rate of the tank between 0.1 to 0.5 gpm at room temperature, and was found to be chatter free with the ball float weighing 0.4 g with 0.375 inch diameter. In contrast, the chatter could be observed for a ball float weighing 1 g but having the same diameter at the same expected water fill rate of the tank between 0.1 to 0.5 gpm at room temperature.

In another presently preferred aspect, the keeper is a triangular or C-shaped clip formed of spring steel, which serves to retain the ball float within the collar. In a presently preferred aspect, the keeper includes a first side arm 45a, a second side arm 45b, a first side base free end 47a, and a second side base free end 47b. Alternatively, the seat valve member can be formed by an O-ring instead of a soft seat to seal the spherical ball float against the vent outlet hole.

The keeper preferably fits within a valve adapter 48, typically made of stainless steel, having an interior flow chamber 50 that connects with the interior chamber of the vent valve body. The valve adapter includes an upper annular flange 49 with an internally threaded surface that mates with the externally threaded surface of the vent valve body. The valve adapter is preferably removably mountable to a tank or other vessel of a beverage maker, so as to be removable for maintenance and or replacement. The spherical ball float thus moves within the lumen of the tubular collar, and is preferably constrained for limited travel up and down the lumen of the tubular collar. For example, when the spherical ball float has a diameter of about 0.375 inch and weighs about 0.4 g, the spherical ball float is preferably limited to move longitudinally within the lumen of the tubular collar a maximum of approximately 0.041 inches.

The valve adapter also includes a flow inlet 52 connected in fluid communication with the interior flow chamber of the valve adapter. The valve adapter preferably has a surface defining an interior shoulder 54 for seating of the keeper as well as an elastomeric O-ring 56, best seen in FIG. 5, which forms a fluid seal between the vent valve body and the valve adapter in the vent valve assembly. The valve adapter is adapted to be attached to a tank assembly of the beverage maker. The keeper, the spherical ball float, the collar, and the valve seat are all contained within the interior chamber of the vent valve body.

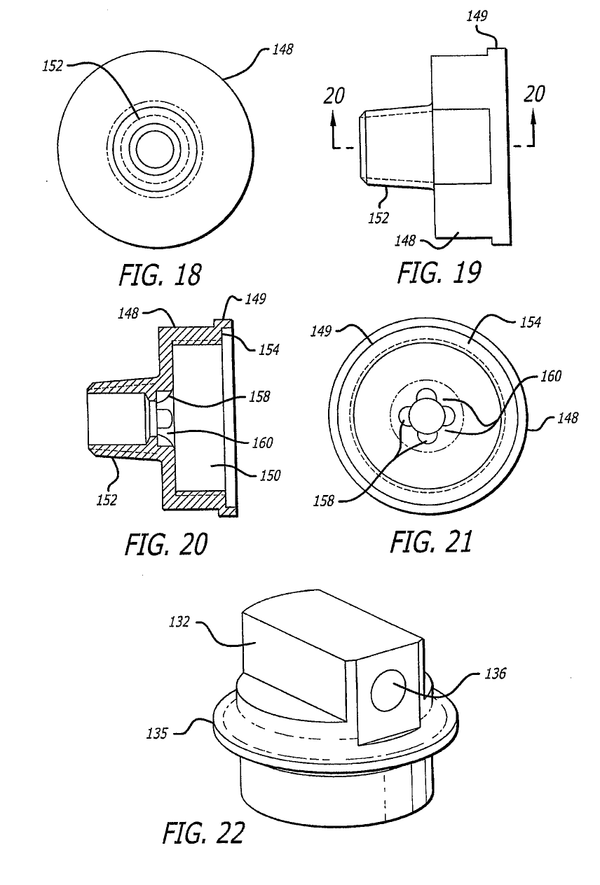

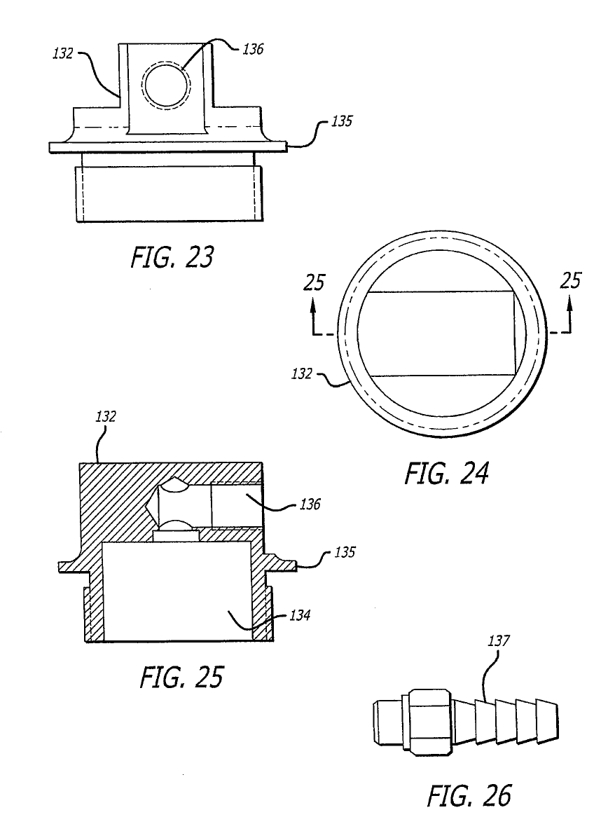

Referring to FIGS. 14-26, in a second preferred embodiment, the present invention provides for an air vent valve assembly 130 having a vent valve body 132, typically made of stainless steel, with an interior chamber 134 illustrated in FIG. 15. The vent valve body includes an outlet flow passage 136 in fluid communication with the interior chamber of the vent valve body. The vent valve body includes an outer annular flange 135 with an externally threaded surface. With reference to FIGS. 14-16, 22, 23 and 26, a barbed tube fitting 137 is attached to the outlet flow passage, allowing for exchange of outside air through the vent valve assembly.

Referring to FIGS. 15 and 16, a spherical ball float or valve element 138, typically made of a tough, corrosion resistant polymer, such as high density polyethylene (HDPE), for example, is movably disposed within a lumen 141 of a tubular collar, or liner 140, which is preferably made of a corrosion and heat resistant material, such as polytetrafluoroethylene (PTFE), available under the trade name TEFLON, for example. In a presently preferred aspect, the lumen of the tubular collar has an internal diameter of about 0.406 inch, and the spherical float has a diameter of about 0.375 inch.

As is illustrated in FIG. 16, the collar is disposed within the interior chamber of the vent valve body between a planar valve seat member or washer 142 having a central flow aperture or vent opening 144. In a presently preferred aspect, the planar valve seat member is made from a soft, resilient elastomeric material, such as silicone, for example, providing the valve seat member with a sufficiently smooth finish to accomplish a leak-free seal by the float against the vent outlet opening in the internal chamber of the vent valve body. The planar valve seat member typically has a Shore A hardness or Durometer of approximately 20-25, with an operating temperature range of about 32-250° F. In a presently preferred aspect, the vent opening of the valve seat member of the vent valve assembly is optimized to allow the flow of air at sufficient rates to disallow instability. For example, a vent opening diameter of about 0.16 inch was found sufficient to relieve air flow at the expected water fill rate of the tank between 0.1 to 0.5 gpm at room temperature, and was found to be chatter free with the ball float weighing 0.4 g with 0.375 inch diameter. In contrast, the chatter could be observed for a ball float weighing 1 g but having the same diameter at the same expected water fill rate of the tank between 0.1 to 0.5 gpm at room temperature.

Referring to FIGS. 15-21, the valve adapter 148, typically made of stainless steel, has an interior flow chamber 150 that connects with the interior chamber of the vent valve body. The valve adapter includes an upper annular flange 149 with an internally threaded surface that mates with the externally threaded surface of the vent valve body. The valve adapter is preferably removably mountable to a tank or other vessel of a beverage maker, so as to be removable for maintenance and or replacement. The spherical ball float thus moves within the lumen of the tubular collar, and is preferably constrained for limited travel up and down the lumen of the tubular collar. For example, when the spherical ball float has a diameter of about 0.375 inch and weighs about 0.4 g, the spherical ball float is preferably limited to move longitudinally within the lumen of the tubular collar a maximum of approximately 0.041 inches.

The valve adapter also includes a flow inlet 152 connected in fluid communication with the interior flow chamber of the valve adapter. The valve adapter preferably has a surface defining an interior shoulder 154 for seating of an elastomeric O-ring 156, best seen in FIG. 16, which forms a fluid seal between the vent valve body and the valve adapter in the vent valve assembly. The valve adapter is adapted to be attached to a tank assembly of the beverage maker. The spherical ball float, the collar, and the valve seat are all contained within the interior chamber of the vent valve body. Referring to FIGS. 20 and 21, the valve adapter includes an interior support surface 158 between the flow inlet and the interior flow chamber of the valve adapter for seating of the ball float. In a presently preferred aspect, the interior support surface includes a plurality of radially projecting outer flow passages or flow notches 160, typically arranged uniformly and symmetrically about the flow inlet passage. The valve adapter interior support surface thus the configuration of the interior support surface of the valve adapter supports the ball float and retains the ball float within the tubular collar without permitting the ball float to become stuck in the bottom of the valve adapter when the ball float is at the bottom of the tubular collar.

The valve assembly is preferably dimensioned such that its performance is easily optimized by adjusting vent opening, the float weight, and the operating pressures in relation to the force of gravity to meet the operating requirements. The valve assembly is also preferably designed to withstand torque forces experienced during the course of manufacturing and maintenance, while the internal components are sufficiently flexible to provide a chatter-free, leak-free, and stick-free reliable operation of the air vent valve assembly.

It should be apparent to those skilled in the art that alternatively the vent valve body can be provided with internal threads instead of external threads, and the valve adapter may be provided with external threads, so that the valve adapter can be lighter in weight, and that the vertical length of the vent valve can be shortened as a whole, resulting in a more compact, light weight design with a shorter profile.

It will be apparent from the foregoing that while particular forms of the invention have been illustrated and described, various modifications can be made without departing from the spirit and scope of the invention. Accordingly, it is not intended that the invention be limited, except as by the appended claims.

We claim:

1. An air vent valve assembly for a tank assembly of a beverage maker for aircraft, comprising:
a vent valve body having an interior chamber and an outlet flow passage in fluid communication with the interior chamber;
a valve adapter that sealingly mates with the vent valve body, the valve adapter being adapted to be attached to the tank assembly of the beverage maker, the valve adapter having an interior flow chamber connected in fluid communication with the interior chamber of the vent valve body, and a flow inlet connected in fluid communication with the interior flow chamber of the valve adapter;
a tubular collar having a lumen disposed within the interior chamber of the vent valve body;
a planar valve seat member disposed within the interior chamber of the vent valve body between the tubular collar and the outflow passage of the vent valve body, the planar valve seat member having a surface defining a central flow aperture; and
a float movably disposed within the lumen of the tubular collar, the float having a first valve seating position abutting and closing the central flow aperture of the planar valve seat member, and a second unseated position spaced apart from and opening the central flow aperture of the planar valve seat member, and wherein the valve adapter includes an interior support surface defining a lower seating of the float in said second unseated position.

2. The air vent valve assembly of claim 1, further comprising a barbed tube fitting attached to the outlet flow passage to allow for exchange of outside air through the vent valve assembly.

3. The air vent valve assembly of claim 1, wherein the vent valve body comprises an outer annular flange with an externally threaded surface, and the valve adapter includes an upper annular flange with an internally threaded surface that mates with the externally threaded surface of the vent valve body.

4. The air vent valve assembly of claim 1, wherein the valve adapter has a surface defining an interior shoulder seating an O-ring forming a fluid seal between the vent valve body and the valve adapter.

5. The air vent valve assembly of claim 1, wherein the tubular collar is made of a corrosion resistant material.

6. The air vent valve assembly of claim 1, wherein the tubular collar is made of polytetrafluoroethylene.

7. The air vent valve assembly of claim 1, wherein the planar valve seat member is made of a soft, resilient elastomeric material.

8. The air vent valve assembly of claim 1, wherein the float is made of high density polyethylene.

9. The air vent valve assembly of claim 7, wherein the valve seat member is made of silicone.

10. The air vent valve assembly of claim 1, wherein said interior support surface includes a plurality of radially projecting outer flow passages.

11. The air vent valve assembly of claim 10, wherein said plurality of radially projecting outer flow passages are arranged uniformly and symmetrically about said flow inlet passage.

12. An air vent valve assembly for a tank assembly of a beverage maker for aircraft, comprising:
a vent valve body having an interior chamber and an outlet flow passage in fluid communication with the interior chamber;
a valve adapter that sealingly mates with the vent valve body, the valve adapter being adapted to be attached to the tank assembly of the beverage maker, the valve adapter having an interior flow chamber connected in fluid communication with the interior chamber of the vent valve body, and a flow inlet connected in fluid communication with the interior flow chamber of the valve adapter;
a tubular collar having a lumen disposed within the interior chamber of the vent valve body;
a planar valve seat member disposed within the interior chamber of the vent valve body between the tubular collar and the outflow passage of the vent valve body, the planar valve seat member having a surface defining a central flow aperture; and
a float valve element movably disposed within the lumen of the tubular collar, the float valve element having a first valve seating position abutting and closing the central flow aperture of the planar valve seat member, and a second unseated position spaced apart from and opening the central flow aperture of the planar valve seat member, and wherein the valve adapter has an interior support surface including a plurality of radially projecting outer flow passages configured to support the float valve element when said float valve element is in said second unseated position and to retain the float valve element within the tubular collar without permitting the float valve element to become stuck in the bottom of the valve adapter when the float valve element is at the bottom of the tubular collar.

13. The air vent valve assembly of claim 12, further comprising a barbed tube fitting attached to the outlet flow passage to allow for exchange of outside air through the vent valve assembly.

14. The air vent valve assembly of claim 12, wherein the vent valve body comprises an outer annular flange with an externally threaded surface, and the valve adapter includes an upper annular flange with an internally threaded surface that mates with the externally threaded surface of the vent valve body.

15. The air vent valve assembly of claim 12, wherein the valve adapter has a surface defining an interior shoulder seating an O-ring forming a fluid seal between the vent valve body and the valve adapter.

16. The air vent valve assembly of claim 12, wherein the tubular collar is made of a corrosion resistant material.

17. The air vent valve assembly of claim 12, wherein the tubular collar is made of polytetrafluoroethylene.

18. The air vent valve assembly of claim 12, wherein the planar valve seat member is made of a soft, resilient elastomeric material.

19. The air vent valve assembly of claim 12, wherein the float valve element is made of high density polyethylene.

20. The air vent valve assembly of claim 18, wherein the valve seat member is made of silicone.
